(19) United States
(12) Patent Application Publication
(10) Pub. No.: US 2009/0013740 A1
(43) Pub. Date: Jan. 15, 2009

(54) Safety lever deadbolt lock

(76) Inventor: Thomas Edward Sanchagrin, Elk Grove, CA (US)

Correspondence Address: THOMAS EDWARD SANCHAGRIN, 9608 BLUE THISTLE WAY, ELK GROVE, CA, 95624, US

(21) Appl. No.: 11/827,528

(22) Filed: Jul. 13, 2007

(51) Int. Cl. E05B 17/20

(52) U.S. Cl. 70/419

(57) ABSTRACT

My invention is to provide a new and useful apparatus for preventing the rotation of a key to open a deadbolt lock or the lock to be picked. By manufacturing the faceplate on the inside of the door out of solid metal. This would allow a slot to be machined in the face plate where I could put in a lever with a pivot screw, allowing the lever to be pulled out keeping the knob from turning and the dead bolt lock from unlocking. This may also be used on a side garage door or any entrance door to a home.

### BACKGROUND OF THE INVENTION

This invention is a security safety device to prevent home invasions. This invention is a lever that is inserted into a faceplate made of solid metal. With a pivot screw inserted into one end of the faceplate and into the lever, allowing the lever to be pulled out to prevent a knob on a deadbolt lock from turning. A deadbolt lock being a key cylinder on the outside of a door and a knob with a faceplate on the inside of said door. In prior art the faceplate is stamped out of a thin piece of sheet metal which does not allow for modification to said faceplate to keep the knob from turning because the sheet metal is to thin.

According to State Farms Article about Choosing the Best Door Lock for your home, posted on the internet says according to a Study by the California Crime Technological Research Foundation, 6.79% of burglars use a pass key or by picking the lock to burglarize single family homes.

### STATE OF THE PRIOR ART

There are other patents describing various devices to keep a knob on a deadbolt lock from turning but most of these inventions are added on requiring more hardware to be added on to the door, such as; U.S. Pat. No. 3,927,293. Another device U.S. Pat. No. 4,947,663 that requires measuring a distance from the top of a knob and then drilling a hole to secure the device. This would require knowledge in the use of certain tools.

### REFERENCES CITED

### U.S. Patent Documents

| | | |
|---|---|---|
| 3927293 | November 1974 | Klein |
| 4947663 | March 1990 | Yeager |

### BRIEF DESCRIPTION OF THE SEVERAL VIEWS OF THE DRAWINGS

### Safety Lever Deadbolt Lock

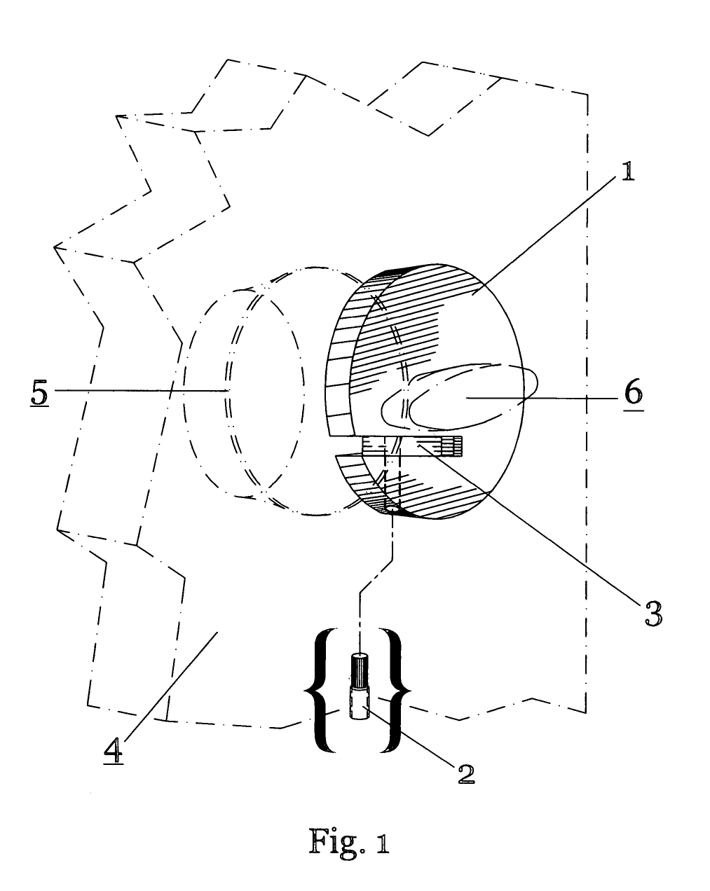

FIG. 1 is a perspective view of the faceplate, the door, the knob, the pivot screw and the key cylinder.

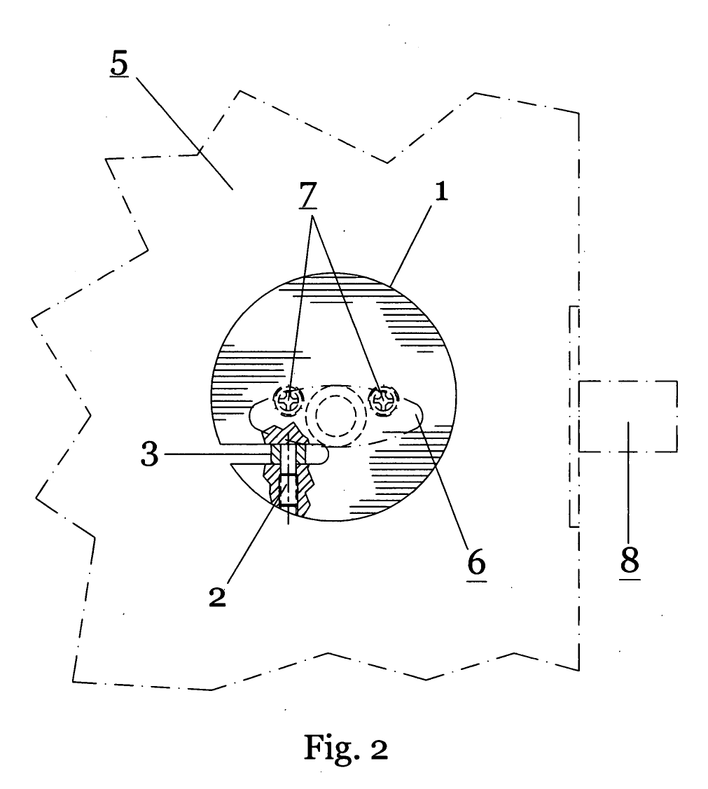

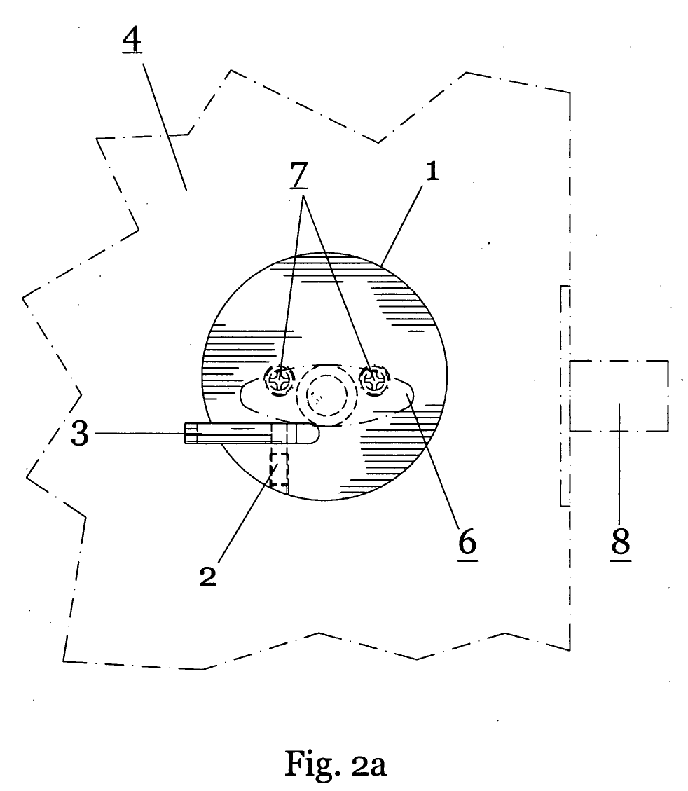

FIG. 2 is a front view showing the faceplate, the pivot screw, the slot, the two assembly screws, the door and the deadbolt.

FIG. 2A is a front view of the faceplate showing the lever inserted in a closed position.

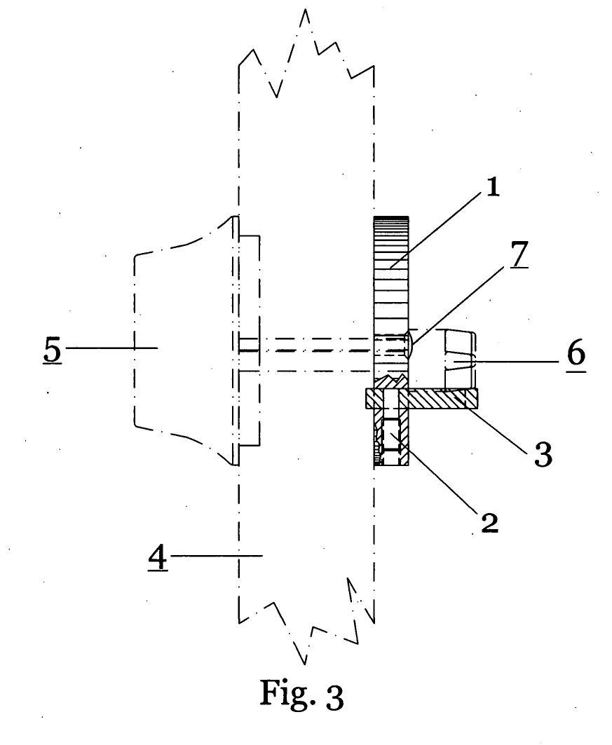

FIG. 3 is a left side view showing the lever in a pulled out position to keep the knob from unlocking.

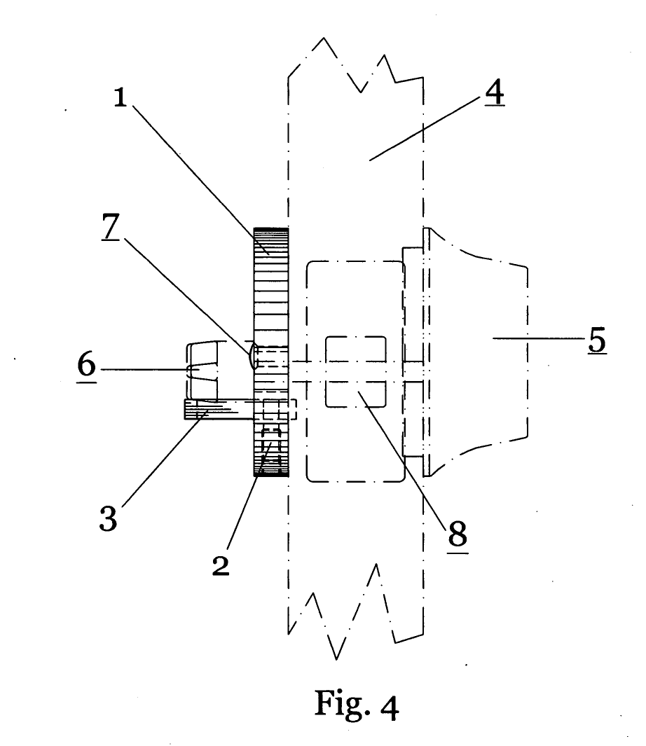

FIG. 4 is a right hand view showing the lever in a pulled out position keeping the knob from turning.

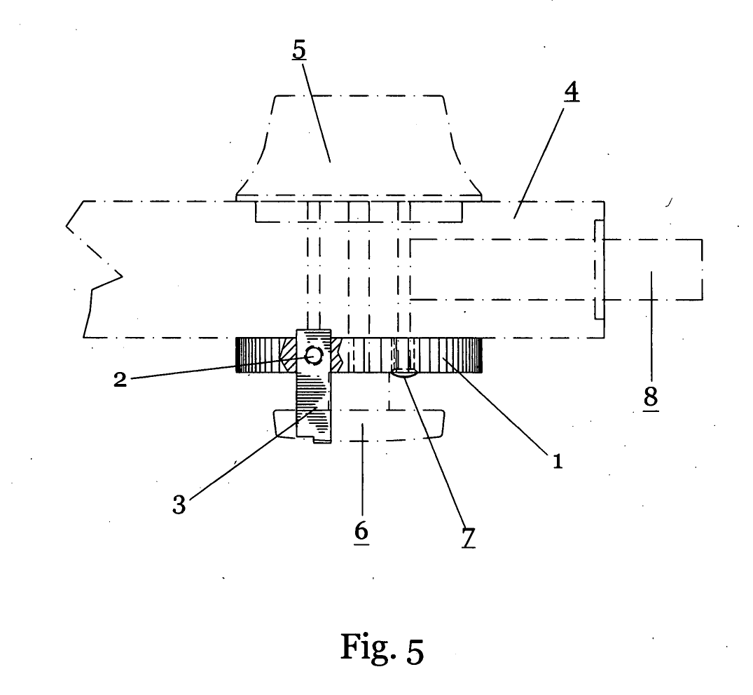

FIG. 5 is a top view that shows the lever in a pulled out position preventing the knob from turning. The lever has a pivot hole on one end and a finger notch on the other end.

### DETAILED DESCRIPTION OF THE INVENTION

FIG. 1 shows a section of a door 4 with a faceplate 1, a slot 3, with the pivot screw 2 and the slot for the lever 3, the knob prior art 6 and the outside key cylinder prior art 5.

FIG. 2 shows the faceplate 1, the two assembly screws prior art 7, the knob 6 in a locked position.

The deadbolt prior art 8, a cut away view of the pivot screw 2 inserted into the slot 3.

FIG. 2A shows the same as FIG. 2 except for the lever 3 is inserted into the faceplate 1 and is in a closed position. When the lever is in a closed position it is flush with said faceplate 1.

FIG. 3 shows the lever 3 in a pulled out position keeping the knob 6 from turning with the pivot screw 2 in place.

FIG. 4 is the opposite view of FIG. 3 showing the lever 3 in a pulled position.

FIG. 5 is the top view showing the lever 3 in a pulled out position with the pivot screw 2 in one end of the lever 3 and a finger notch in the other end of the lever.

1. What I claim as my invention is a safety lever device built into a face plate at a location just below the knob of a deadbolt lock assembly with a pivot screw to hold said lever in place. Said deadbolt lock assembly being a key cylinder on the outside of a door and said face plate with said knob on the inside of said door to lock and unlock said door.

2. Said face plate in claim 1 being made from solid metal with a slot for said lever and a threaded hole for said pivot screw to hold said lever in place. Also two holes for mounting screws and one hole for said knob.

3. Said lever with a hole in one end for said pivot screw and a finger notch on the other end to pull said lever out to keep said knob from unlocking by a key or by being picked when said knob is in a locked position.

4. Said pivot screw as in claim 1 that is threaded on one end and smooth on the other end.

5. (canceled)

6. (canceled)
